(19) United States
(12) Patent Application Publication
(10) Pub. No.: US 2026/0081683 A1
(43) Pub. Date: Mar. 19, 2026

(54) Automatic Shared Risk Link Group Detection

(71) Applicant: Ciena Corporation, Hanover, MD (US)

(72) Inventors: David W. Boertjes, Ottawa (CA); Alex W. MacKay, Ottawa (CA); Andrew D. Shiner, Ottawa (CA)

(73) Assignee: Ciena Corporation, Hanover, MD (US)

(21) Appl. No.: 18/887,110

(22) Filed: Sep. 17, 2024

(51) Int. Cl. H04B 10/079; H04B 10/25

(52) U.S. Cl. CPC H04B 10/0795; H04B 10/25

(57) ABSTRACT

A method for detecting shared risk link is provided. The method can include receiving physical measurements from a plurality of fibers in an optical network, correlating the plurality of fibers to one another by analyzing the physical measurements to predict which fibers of the plurality of fibers share common infrastructure, and providing details of the fibers that share common infrastructure.

### FIELD OF THE DISCLOSURE

The present disclosure relates generally to networking and computing. More particularly, the present disclosure relates to systems and methods for analyzing physical measurements to correlate fibers which share common infrastructure for automatic Shared Risk Link Group (SRLG) detection.

### BACKGROUND OF THE DISCLOSURE

Shared Risk Group (SRG) is a concept in network routing that a group of connections may suffer from a common failure if they share a common risk. SRG can be used with optical networks, Ethernet networks, Multiprotocol Label Switching (MPLS) networks including the Generalized Multiprotocol Label Switching (GMPLS) networks, Internet Protocol (IP) networks, and the like as well as multi-layer networks. An SRG failure makes multiple connections go down because of the failure of a common resource those connections share. Examples of SRGs include Shared Risk Link Group (SRLG), Shared Risk Node Group (SRNG), Shared Risk Equipment Group (SREG), etc. An SRLG is a risk on a cable or the like, an SRNG is a risk associated with a node or network element, and an SREG is a risk that extends within the node or network element itself, e.g., down to a module or other type of equipment. The descriptions herein reference SRLGs and focus on determining shared risk on a link, e.g., fibers sharing common infrastructure. SRLGs refer to situations where links in a network share a common fiber (or a common physical attribute such as fiber conduit or the like), and if one link fails, other links in the group may fail too, i.e., links in the group have a shared risk which is represented by the SRLG. SRLGs are used in optical, Ethernet, MPLS, GMPLS, and/or IP networks and used for route computation to ensure diversity.

In multi-layer networks, a link at an upper layer has a connection at a lower layer, and thus any network resources (links, nodes, line cards, and the like) used by the lower layer connection can be represented as SRLGs on the upper layer links. That is, MPLS tunnels, Optical Transport Network (OTN) connections, IP routes, etc. all operate on a lower layer optical network (Layer 0). For example, an MPLS link at an MPLS layer may have an SRLG to represent a connection at Layer 0 and thus any optical nodes, amplifiers, and multiplexing components, as well as fiber cables and conduits used by the Layer 0 connection, are accounted for in SRLGs on the MPLS link. As an example, one would not want to protect MPLS tunnels where the protected tunnels share a risk in an optical network. The SRLGs are used in the MPLS route computation to ensure the protected tunnels share no common risks in the optical network. That is, route or path computation can compare SRLGs of links between two paths to determine if they are disjoint or not. If two paths have a common risk, i.e., share an SRLG, there is a possibility of a common fault taking both paths down. Of course, this defeats the purpose of protection and is to be avoided.

The current approach is to rely on human input to assign a common risk to a set of fibers. This is commonly known and SRLG data can be tracked by the system in various locations including in the network element by the control plane, in the network management system (NMS) software, and in the planning software. This manual input is cumbersome and often prone to omissions and errors. Further, the user needs to coordinate the input into the various locations including the network element, NMS, and planning software, which may be used by different teams or even different organizations. This often results in the maintenance of this data being particularly difficult. Also, network operators often do not have good data related to their fiber infrastructure adding further uncertainty, which is a particular focus herein.

### BRIEF SUMMARY OF THE DISCLOSURE

The present disclosure relates to systems and methods for automatic shared risk link group detection using physical measurements, such as Optical Time Domain Reflectometry (OTDR), detected events, and the like, to characterize optical fibers and determine which fibers are likely sharing common infrastructure. This can be used for automatic shared risk link group detection. In an embodiment, OTDR traces can be used to determine information about a fiber, such as data on point losses, point reflections, attenuations, fiber core size, location, splices, or more. The present disclosure utilizes common features in OTDR traces on different fibers to infer different fibers share common infrastructure. In other embodiments, a physical measurement can be taken from fibers which can be used to identify which of the fibers share a common link or are in proximity, e.g., detection of events at a given time. Here, two similar events at the same time on two different fibers can be used to infer the two different fibers share common infrastructure. That is, variously, the present disclosure includes automatic detection of shared risk link group based on measurements associated with optical fiber and optical equipment in the same path as the optical fibers.

In various aspects, the present disclosure includes a method having steps, an apparatus configured to implement the steps, and a non-transitory computer-readable medium storing instructions that, when executed, cause one or more processors to implement the steps. The steps include receiving physical measurements from a plurality of fibers in an optical network; correlating the plurality of fibers to one another by analyzing the physical measurements to predict which fibers of the plurality of fibers share common infrastructure; and providing details of the fibers that share common infrastructure. The steps can further include automatically assigning Shared Risk Link Group (SRLG) data to the fibers that share common infrastructure. The steps can further include propagating the SRLG data to the optical network. The steps can further include, prior to the correlating, filtering out the plurality of fibers based on geographical locations or a corresponding length of any fibers.

The physical measurements can be optical time domain reflectometer (OTDR) traces, and wherein the correlating can be based on comparing one or more aspects of the OTDR traces for identifying similarities. The one or more aspects of the OTDR traces can include splices on the fibers being at similar locations at some point thereby indicating a same cable or conduit for the common infrastructure. The one or more aspects of the OTDR traces can include connectors on the fibers being at similar locations thereby indicating exiting from a same cable or conduit for the common infrastructure. The one or more aspects of the OTDR traces can include different fiber types of the fibers being at similar locations at some point. The one or more aspects of the OTDR traces can include bend losses in the fibers being at similar locations thereby indicating excess fiber for slack in the fibers for the common infrastructure.

The physical measurements can be time-based results related to any of loss, events, and polarization changes, and wherein the correlating is based on the fibers exhibiting similar time-based results. The common infrastructure includes the fibers sharing one of a same cable and a same conduit. The steps can further include receiving feedback based on the details, the feedback indicating whether or not the predicted fibers share the common infrastructure; and utilizing the feedback for updating the correlating. The providing can further include an estimate of a probability that there is a shared risk between any two fibers.

### BRIEF DESCRIPTION OF THE DRAWINGS

The present disclosure is detailed through various drawings, where like components or steps are indicated by identical reference numbers for clarity and consistency.

FIG. 1 is a network diagram of a network of network elements interconnected by links.

FIG. 2 is a block diagram of an example network element (node) for use with the systems and methods described herein.

FIG. 3 is a block diagram of a controller which can form a controller for the network element, a PCE, an SDN controller, a management system, or the like.

FIG. 4 is an example OTDR trace through a fiber in accordance with one aspect of the present disclosure.

FIG. 5 is an alternative example OTDR trace through a fiber with analysis of the courses of various events or features in the data in accordance with the present disclosure.

FIG. 6 is a bidirectional analysis of OTDR traces with correlation to cable location in further accordance with the present disclosure.

FIG. 7 is a flowchart of a process for automatic shared risk link group detection in accordance with one aspect of the present disclosure.

### DETAILED DESCRIPTION OF THE DISCLOSURE

Again, the present disclosure relates to systems and method for automatic shared risk link group detection. For example, the present disclosure relates to systems and methods which can incorporate physical measurements, such as OTDR measurements, detected events, etc. to determine different fibers share common infrastructure. The present disclosure can include analyzing an OTDR trace from a fiber, and correlating the trace to other fibers to look for common signatures with the understanding that fibers sharing common infrastructure (cables, conduits, poles, etc.) should have various similar or common characteristics. As used herein, a fiber conduit can be any housing or location where fibers are stored. Moreover, a conduit can contain fibers. Further, a cable as described herein can house or contain fibers.

The present disclosure generally relates to system and methods for shared risk link group (SRLG) detection. More specifically, systems and methods utilize physical measurements of fibers to identify SRLGs in the fibers. The present disclosure can include determining fiber parameters. The fiber parameters can be anything which can be physically measured. For example, the fiber parameters can be determined by an OTDR trace as well as detected events, such as a lightning strike, mechanical vibrations, etc., e.g., causing polarization activity or transients. The present disclosure can include measuring the fiber parameters. With the fiber parameters, the systems and methods determine fibers in close proximity, shared link, or common infrastructures of one another, such as for purposes of shared risks.

Of note, as described herein, the shared risks are referred to as SRLGs. Advantageously, some embodiments of the present disclosure can be adapted to identify SRLGs. Moreover, the present disclosure can be applied to increase the detail or quality of fiber records, and can be implemented to find fiber end points and fiber paths. Advantageously, the techniques described herein can assist network operators in fiber management in their networks, overcoming existing manual approaches which are error prone.

The present disclosure can include determining if two or more fibers share common infrastructure, by comparing one or more measurements of the two or more fibers. For example, in some embodiments, if the measurements between the two or more fibers are substantially similar, the present disclosure includes determining that the two or more fibers share common infrastructure. It is contemplated herein that, if two or more fibers demonstrate similar measurements, reactions, indicia, or the like, that they may be located proximally. In some embodiments, two or more fibers include a parameter, wherein the parameter is a physical aspect which can be measured. For example, the present disclosure can include taking one or more physical measurements of two or more fibers, wherein the physical measurements can be an OTDR trace. Different OTDR traces are compared for identifying or quantifying the similarities between the trace or physical measurements of each of the two or more fibers. A common infrastructure can be determined based on the degree of similarity between the physical measurements of the two or more fibers. Moreover, the present disclosure can include comparing the time which the physical measurements occur, wherein if the time of occurrence is substantially similar, a prediction can be made which identifies a common infrastructure or link.

In further example, the present disclosure can include inferring if two or more fibers share common infrastructure or a common link. The present disclosure can include taking a physical measurement of two or more fibers, for example, an OTDR trace. Also, if the two or more of the fibers physical measurements identify present disclosure events occurring at substantially the same time or regions of traces that are substantially similar, the method can include inferring that the two or more fibers have some degree of commonality, such as a common infrastructure. Fibers sharing common infrastructure can be used to assign a shared risk to the two or more fibers. It is envisioned that such assessments can be used to influence fiber management strategies.

### Example Network

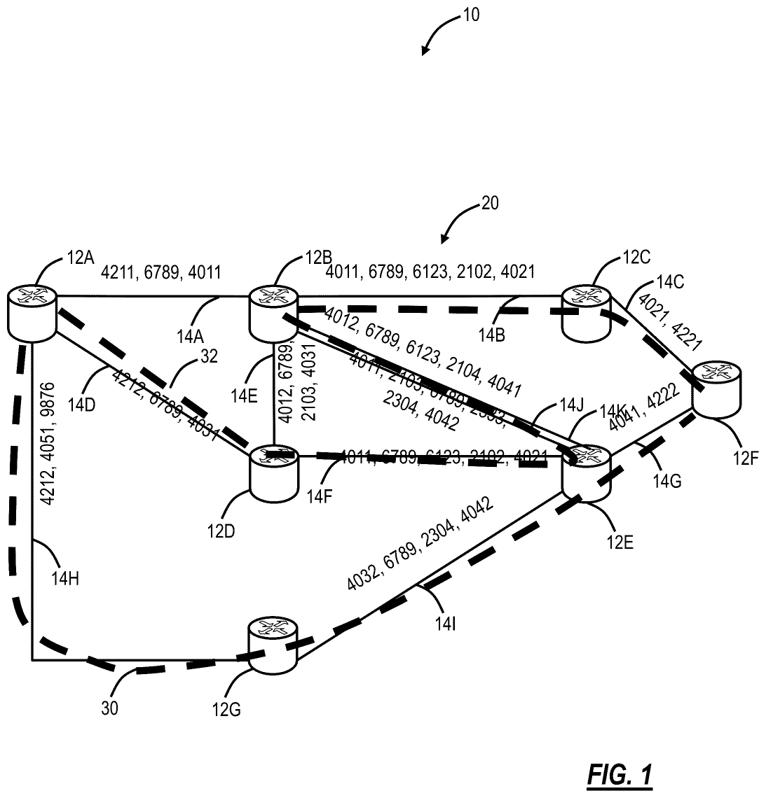

FIG. 1 is a network diagram of a network 10 of network elements 12 (labeled as network elements 12A-12G) interconnected by links 14 (labeled as links 14A-14I). The network elements 12 communicate with one another over the links 14 through Layer 0 (L0) such as optical wavelengths (Dense Wave Division Multiplexing (DWDM)), Layer 1 (L1) such as OTN, Layer 2 (L2) such as Ethernet, MPLS, etc., Layer 3 (L3) protocols, and/or combinations thereof. The network elements 12 can be network elements which include a plurality of ingress and egress ports forming the links 14. The network elements 12 can be switches, routers, cross-connects, etc. operating at one or more layers. An example network element 12 implementation is illustrated in FIG. 1. The network 10 can include various services or calls between the network elements 12. Each service can be at any of the L0, L1, L2, and/or L3 protocols, such as a wavelength, a Subnetwork Connection (SNC), an LSP, a tunnel, a connection, etc., and each service is an end-to-end path and from the view of the client signal contained therein, it is seen as a single network segment. The network 10 is illustrated, for example, as an interconnected mesh network, and those of ordinary skill in the art will recognize the network 10 can include other architectures, with additional network elements 12 or with fewer network elements 12, etc. as well as with various different interconnection topologies and architectures.

The network 10 can include a control plane operating on and/or between the network elements 12. The control plane includes software, processes, algorithms, etc. that control configurable features of the network 10, such as automating discovery of the network elements 12, capacity on the links 14, port availability on the network elements 12, connectivity between ports; dissemination of topology and bandwidth information between the network elements 12; calculation and creation of paths for calls or services; network-level protection and restoration; and the like. In an embodiment, the control plane can utilize Automatically Switched Optical Network (ASON) as defined in G.8080/Y.1304, Architecture for the automatically switched optical network (ASON) (02/2005), the contents of which are herein incorporated by reference; Generalized Multi-Protocol Label Switching (GMPLS) Architecture as defined in Request for Comments (RFC): 3945 (10/2004) and the like, the contents of which are herein incorporated by reference; Optical Signaling and Routing Protocol (OSRP) which is an optical signaling and routing protocol similar to PNNI (Private Network-to-Network Interface) and MPLS; or any other type control plane for controlling network elements at multiple layers, and establishing and maintaining connections between nodes. Those of ordinary skill in the art will recognize the network 10 and the control plane can utilize any type of control plane for controlling the network elements 12 and establishing, maintaining, and restoring calls or services between the nodes 12. In another embodiment, the network 10 can include a Software-Defined Networking (SDN) controller for centralized control. In a further embodiment, the network 10 can include hybrid control between the control plane and the SDN controller. In yet a further embodiment, the network 10 can include a Network Management System (NMS), Element Management System (EMS), Path Computation Element (PCE), etc. That is, the present disclosure is not limited to a control plane, SDN, PCE, etc. based path computation technique.

Again, SRLGs are risks that are compared between two potential paths to ensure diversity between them. The risks can include, without limitation, fibers, fiber conduits, fiber cables, physical junctions, bridges, Reconfigurable Optical Add/Drop Multiplexer (ROADM) degree, intermediate line amplifier, network element 12, a module in the network element 12, or any physical construct associated with the link 14 physically. For diversity, the SRLGs between two connections are compared, and any shared risk indicates a diversity concern or single point of failure for both connections. The objective of SRLGs is to model various risks to enable comparison during route computation.

In FIG. 1, each link 14 is assigned associated SRLGs 20 for risks, and each is a unique value. For example, the link 14A has SRLGs 4211, 6789, 4011 and the link 14B has SRLGs 4011, 6789, 6123, 2102, 4021. In path computation, the fact these two links 14A, 14B have the same SRLGs 6789, 4011 indicates these links 14A, 14B have a common risk and are not diverse/disjoint. The link 14H has SRLGs 4212, 4051, 9876, and when compared to the link 14A, there are no common SRLGs, and thus these two links 14A, 14H are diverse, i.e., no common risk. Depending on the network 10 implementation, the SRLGs 20 can be flooded (in a control plane), managed (in an SDN controller, NMS, EMS, PCE, etc.), or the like.

As an example, assume there are two connections 30, 32 between the network elements 12A, 12F, e.g., the connection 30 can be a primary tunnel (LSP), and the connection 32 can be a backup tunnel (LSP). Thus, there is a requirement for the connection 30 and the connection 32 to be disjoint, i.e., that they do not share a network risk. The connection 30 has a path over links 14H, 14I, 14G. The path for the connection 32 is calculated, and then all of the network risks on the calculated path are compared to the network risks on the path for the connection 30.

### Example Network Element/Node

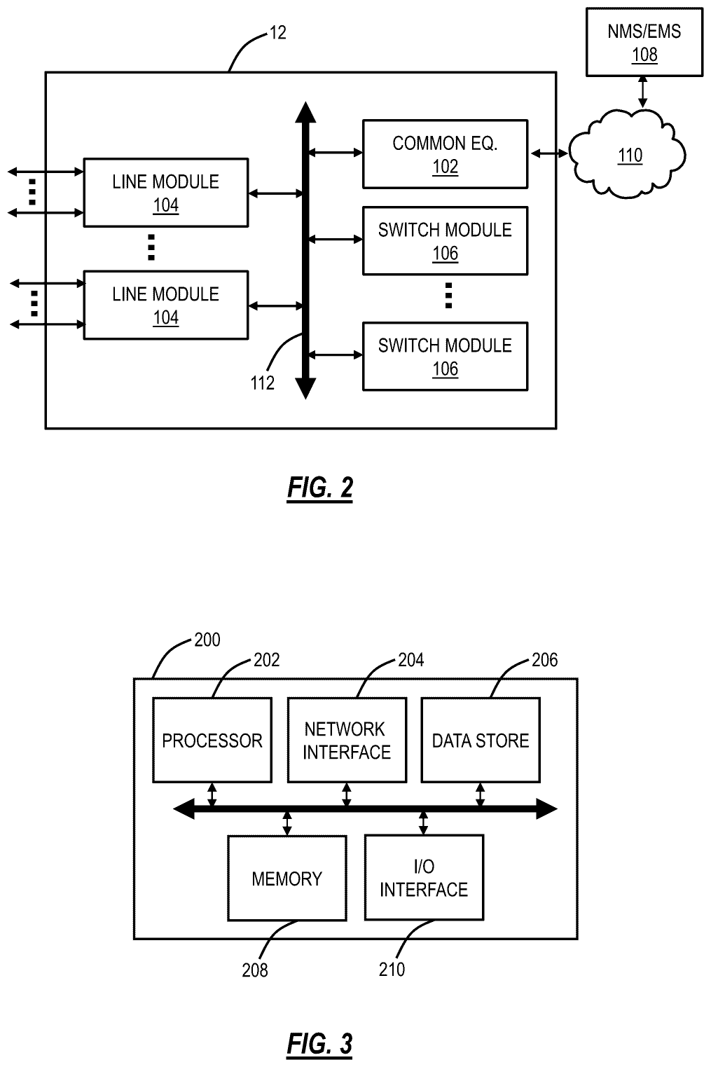

FIG. 2 is a block diagram of an example network element 12 (node) for use with the systems and methods described herein. In an embodiment, the network element 12 can be a device that may consolidate the functionality of a Multi-Service Provisioning Platform (MSPP), Digital Cross-Connect (DCS), Ethernet and/or Optical Transport Network (OTN) switch, Wave Division Multiplexed (WDM)/DWDM platform, Packet Optical Transport System (POTS), etc. into a single, high-capacity intelligent switching system providing Layer 0, 1, 2, and/or 3 consolidation. In another embodiment, the network element 12 can be any of an OTN Add/Drop Multiplexer (ADM), a Multi-Service Provisioning Platform (MSPP), a Digital Cross-Connect (DCS), an optical cross-connect, a POTS, an optical switch, a router, a switch, a WDM/DWDM terminal, an access/aggregation device, etc. That is, the network element 12 can be any digital and/or optical system with ingress and egress digital and/or optical signals and switching of channels, timeslots, tributary units, wavelengths, etc.

In an embodiment, the network element 12 includes common equipment 102, one or more line modules 104, and one or more switch modules 106. The common equipment 102 can include power; a control module; Operations, Administration, Maintenance, and Provisioning (OAM&P) access; user interface ports; and the like. The common equipment 102 can connect to a management system 108 through a data communication network 110 (as well as a PCE, an SDN controller, etc.). Additionally, the common equipment 102 can include a control plane processor, such as a controller 200 illustrated in FIG. 3 configured to operate the control plane as described herein. The network element 12 can include an interface 112 for communicatively coupling the common equipment 102, the line modules 104, and the switch modules 106 to one another. For example, the interface 112 can be a backplane, midplane, a bus, optical and/or electrical connectors, or the like. The line modules 104 are configured to provide ingress and egress to the switch modules 106 and to external connections on the links to/from the network element 12. Other configurations and/or architectures are also contemplated.

Further, the line modules 104 can include a plurality of optical connections per module, and each module may include a flexible rate support for any type of connection. The line modules 104 can include WDM interfaces, short-reach interfaces, and the like, and can connect to other line modules 104 on remote network elements, end clients, edge routers, and the like, e.g., forming connections on the links in the network 10. From a logical perspective, the line modules 104 provide ingress and egress ports to the network element 12, and each line module 104 can include one or more physical ports. The switch modules 106 are configured to switch channels, timeslots, tributary units, packets, etc. between the line modules 104. For example, the switch modules 106 can provide wavelength granularity (Layer 0 switching); OTN granularity; Ethernet granularity; and the like. Specifically, the switch modules 106 can include Time Division Multiplexed (TDM) (i.e., circuit switching) and/or packet switching engines.

Those of ordinary skill in the art will recognize the network element 12 can include other components which are omitted for illustration purposes, and that the systems and methods described herein are contemplated for use with a plurality of different network elements with the network element 12 presented as an example type of network element. For example, in another embodiment, the network element 12 may not include the switch modules 106, but rather have the corresponding functionality in the line modules 104 (or some equivalent) in a distributed fashion. Also, the network element 12 may omit the switch modules 106 and that functionality, such as in a DWDM terminal. For the network element 12, other architectures providing ingress, egress, and switching are also contemplated for the systems and methods described herein. In general, the systems and methods described herein contemplate use with any network element, and the network element 12 is merely presented as an example for the systems and methods described herein.

### Physical Measurements

In conjunction with operation in the network 10, the network element 12 is configured to collect monitoring data, Performance Monitoring (PM) data, OAM&P data, and the like, during operation. For purposes of the present disclosure, the relevant collected data is referred to as physical measurements which includes anything that can be used to uniquely identify parameters of a fiber, such that comparisons can be made between fibers for inferring they share common infrastructure.

One example type of physical measurement is an OTDR trace. For example, the line modules 104 typically operate in some wavelength range, such as the C-band (˜1530-1565 nm), the L-band (˜1565-1625 nm), etc. The network element 12 can include an OTDR device that operates outside these wavelength ranges, e.g., at 1625 nm, allowing the network element 12 to perform in-service OTDR measurements periodically, which can be provided externally for purposes of implementing the present disclosure.

Another type of physical measurement involves polarization tracking such as based on a polarimeter. Similar to the OTDR device, the network element 12 can include a polarimeter which operates outside these wavelength ranges, similarly allowing in-service polarization monitoring. The polarimeter can be used to detect polarization transients which are events in time, and which can be provided externally for purposes of implementing the present disclosure.

Those skilled in the art will appreciate the present disclosure contemplates any physical measurement in the network 10 which can be used to uniquely identify fibers for purposes of predicting two fibers share common infrastructure. For example, another example could be a fault that affects two independent fibers simultaneously, clearly indicating a cable cut, meaning these two independent fibers were cut at the same time.

### Example Controller

FIG. 3 is a block diagram of a controller 200 which can form a controller for the network element 12, a PCE, an SDN controller, a management system, or the like. The controller 200 can be part of the common equipment, such as common equipment 102 in the network element 100, or a stand-alone device communicatively coupled to the network element 100 via the data communication network 110. In a stand-alone configuration, the controller 200 can be the management system 108, a PCE, etc. The controller 200 can include a processor 202 which is a hardware device for executing software instructions such as operating the control plane. The processor 202 can be any custom made or commercially available processor, a central processing unit (CPU), an auxiliary processor among several processors associated with the controller 200, a semiconductor-based microprocessor (in the form of a microchip or chipset), or generally any device for executing software instructions. When the controller 200 is in operation, the processor 202 is configured to execute software stored within the memory, to communicate data to and from the memory, and to generally control operations of the controller 200 pursuant to the software instructions. The controller 200 can also include a network interface 204, a data store 206, memory 208, an I/O interface 210, and the like, all of which are communicatively coupled to one another and to the processor 202.

The network interface 204 can be used to enable the controller 200 to communicate on a Data Communication Network (DCN), such as to communicate control plane information to other controllers, to a management system, to the network elements 12, and the like. The network interface 204 can include, for example, an Ethernet module. The network interface 204 can include address, control, and/or data connections to enable appropriate communications on the network. The data store 206 can be used to store data, such as control plane information, provisioning data, OAM&P data, etc. The data store 206 can include any of volatile memory elements (e.g., random access memory (RAM, such as DRAM, SRAM, SDRAM, and the like)), nonvolatile memory elements (e.g., ROM, hard drive, flash drive, CDROM, and the like), and combinations thereof. Moreover, the data store 206 can incorporate electronic, magnetic, optical, and/or other types of storage media. The memory 208 can include any of volatile memory elements (e.g., random access memory (RAM, such as DRAM, SRAM, SDRAM, etc.)), nonvolatile memory elements (e.g., ROM, hard drive, flash drive, CDROM, etc.), and combinations thereof. Moreover, the memory 208 may incorporate electronic, magnetic, optical, and/or other types of storage media. Note that the memory 208 can have a distributed architecture, where various components are situated remotely from one another, but may be accessed by the processor 202. The I/O interface 210 includes components for the controller 200 to communicate with other devices. Further, the I/O interface 210 includes components for the controller 200 to communicate with the other nodes, such as using overhead associated with OTN signals.

The controller 200 is configured to implement software, processes, algorithms, etc. that can control configurable features of the network 10, such as automating discovery of the network elements 12, capacity on the links 14, port availability on the network elements 12, connectivity between ports; dissemination of topology and bandwidth information between the network elements 12; path computation and creation for connections; network-level protection and restoration; and the like. As part of these functions, the controller 200 can include a topology database that maintains the current topology of the network 10, such as based on control plane signaling and a connection database that maintains available bandwidth on the links again based on the control plane signaling as well as management of the network risks for diverse path computation 12, connectivity between ports; dissemination of topology and bandwidth information between the network elements 12; path computation and creation for connections; network-level protection and restoration; and the like. As part of these functions, the controller 200 can include a topology database that maintains the current topology of the network 10, such as based on control plane signaling and a connection database that maintains available bandwidth on the links again based on the control plane signaling as well as management of the network risks for diverse path computation.

### Problem Statement

It is quite common for network operators to have incomplete or errant fiber records for the network 10. Such operators can struggle identifying fiber end points and discovering exact paths. This is exacerbated when designing route networks and makes the assignment of shared risk link groups nearly impossible. It is also of note that a lot of network operators lease or buy fiber infrastructure from other providers.

Shared risk link groups (SRLGs), as used herein, can refer to a concept in networking which can describe a group of network links that share a common risk of failure. The risk of failure can be physical, such as physical damage, electronic, or network related. Sometimes, the failure can be a result of logical dependencies. For example only, the failures can result from sharing the same physical conduit, sharing the same geographical route, or common network equipment. It is important to understand SRLGs as they can aid in designing resilient networks. Further a proper SRLG can be effective to ensure that redundant paths do not share the same risk. In many aspects, SRLGs can be configured to help a network operator or user identify and manage potential points of failure. Further SRLGs can be configured to enable proactive measurements to mitigate risks.

The Concept of Route Redundancy and Path computation can rely on the intrinsic assumption that the SRLG are known. In some estimations, it is likely that less than 40% of fibers have any Geographic Information System (GIS) information that can provide insight into the physical location. Further, such GIS information may not include information about splice enclosures or conduits. As used herein, the term “splice” can refer to a connection made between two or more optical fibers, for example, an end-to-end fiber optic joint which can enable the transmission of radiation therethrough. Splices can cause fibers to reroute, and potentially share common infrastructure with other fibers. This can be done at some point in time and not necessarily be reflected in the operator's records. Here, a diverse connection may be established over two fibers that are unknown to have a shared risk.

### Existing Solutions

Currently, approaches to solve fiber analysis can include relying on human input to assign a common risk to a set of fibers. The risk can be an estimation based on records of the fiber or its surroundings. Data from the records is used for SRLG data. Such SRLG data can be tracked by a system in various locations including in the network element (NE), by the control plane (CP), or in the network management system (NMS) software or planning software.

Manual input of this type can be cumbersome and prone to oversight, errors, and omissions. In addition, the user needs to coordinate the input into the various locations including the NMS and planning software, which may be used by different teams or even different organizations, which can make the maintenance of such data difficult. Further, such data can be outdated due to physical changes in the network.

### OTDR Traces

As used herein, OTDR is an instrument configured to characterize one or more parameters of a fiber. The OTDR is a device which can be configured to send one or more optical pulses into a fiber and then measure the reflected signals that return from various points along the fiber. Such reflections are the result of discontinuities, such as splices, connectors, bends, and breaks. In typical aspects, the OTDR outputs information as tabular data which may be presented in a graph, or more generally, in a means to visualize the fiber's condition. The OTDR generates a trace which can be a graphical representation of the fiber's properties, such as length, etc. Such a trace can be analyzed to determine properties of the fiber.

Variously, the present disclosure can utilize an OTDR for determining physical measurements of fibers for predicting whether two fibers share common infrastructure. For example, some embodiments can include analyzing OTDR traces. More generally, any physical measurement can be used to determine characteristics of fibers. That is, OTDR is one approach for physical measurements, but any other types of measurements are also contemplated. The present disclosure includes the insight that fibers sharing some aspects of physical measurements are likely to share the same common infrastructure. Machine learning (ML) or artificial intelligence (AI) can be incorporated to help analyze measurements from the measuring device, such as the OTDR.

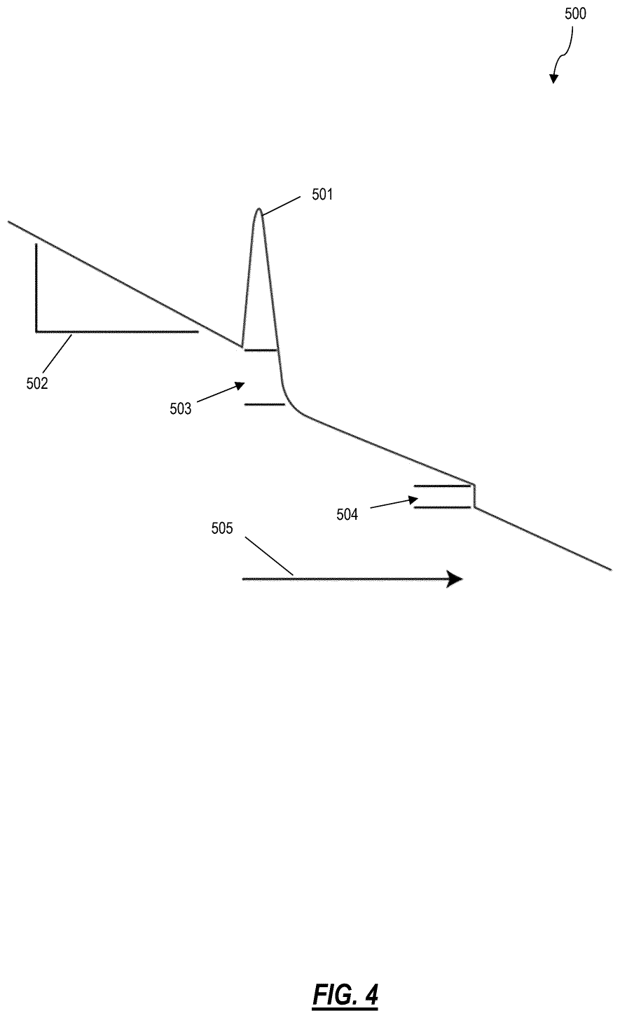

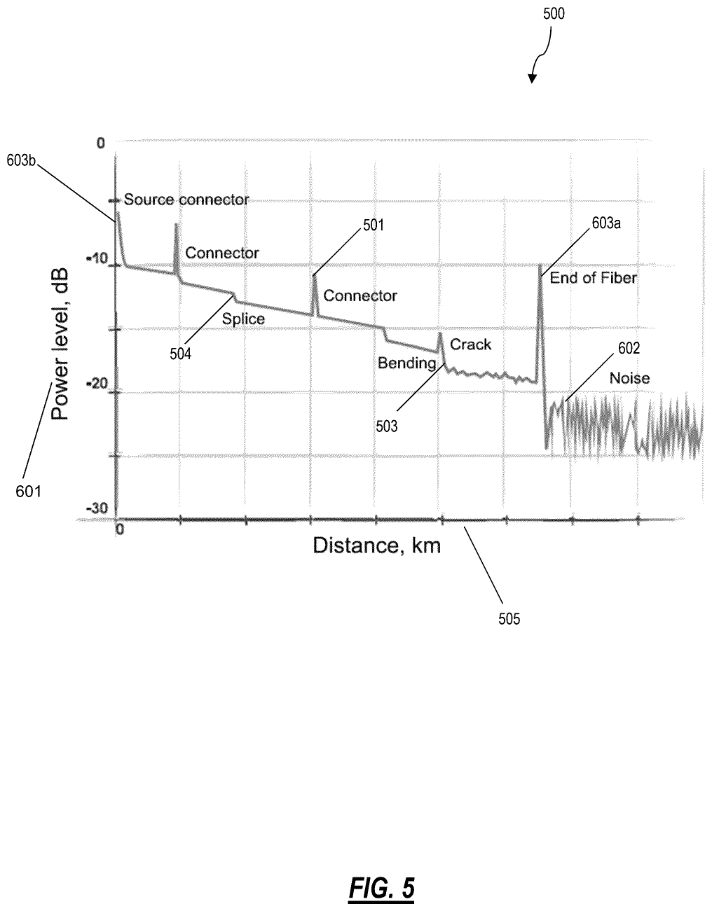

Turning now to FIG. 4, an example OTDR trace through a fiber in accordance with one aspect of the present disclosure is shown and described. The OTDR, and more generally the measurement system or any portion thereof can be configured to output data. The data can be an OTDR trace 500. The OTDR trace 500 can be in a data form, such as in a graph. The OTDR trace 500 can contain information about the fiber. More specifically, the OTDR trace 500 can provide data on any of point losses, point reflection attenuation, fiber core size, or model field diameter (MFD), fiber span length, overall loss, etc. The OTDR trace 500 can be configured to localize the data. For example, the OTDR can be configured to localize data in distance from the launch point of the OTDR. The launch point of the OTDR can be at one end of the fiber span. In other aspects, the launch point can be at two ends of the fiber span.

The OTDR trace 500 can include at least a reflection 501, a slope 502, and a loss 503 such as a splice loss 504. The OTDR trace 500 can be defined over a distance 505. The OTDR trace 500 can show reflected light from the fiber. The light that is reflected can be the OTDR light pulse. In typical examples, there can be a nominal background level of reflectance in the fiber, such as scattering which can be Rayleigh Backscatter. The light pulse, or portions thereof, can be reflected back toward the receiver as the pulse propagates down the fiber. The pulse can be reduced in power by the attenuation of the fiber as it propagates down the fiber. As a result, the reflected light can experience attenuation that increases with propagation distance. Therefore, the OTDR trace 500 can be modeled as the slope 502. Even if a fiber with unform backscatter (i.e., no additional reflection or losses) is measured, the OTDR trace 500 is expected to show the slope 502. The slope 502 of the OTDR trace 500 can defined over the distance 505. The distance 505 can be the horizontal axis of the OTDR trace 500 and can represent the total fiber distance. The OTDR trace 500 can define a signal loss or reflection on the axis perpendicular to the distance 505.

In typical aspects, the OTDR trace 500 can be expected to show a constant slope 502. The constant slope 502 can represent a constant power reduction in the reflection 501 as the pulse propagates down the fiber. The OTDR trace 500 can exhibit the reflection 501 based on an event. Such events can be without limitation a splice, a connector, a bend, a break, a fiber end, or the like. The reflection 501 can be defined in the OTDR trace 500 as a spike in the slope 502. In an example aspect, the fiber can experience an air gap in a connection which can cause a reflection 501 in the OTDR trace 500. The reflection 501 can appear as an upward spike in detecting power and subsequently as an upward spike on the OTDR trace 500. The reflection 501 can define an initiation and a termination, wherein the initiation and termination are inflection points on the slope 502. The reflection 501 can define the loss 503 which can be a point on the OTDR trace 500 between the initiation and termination of the reflection 501. The loss 503 can be defined in the OTDR trace 500 as the power difference in between the initiation and the termination of the reflection 501 on the OTDR trace 500. The loss 503 can be the splice loss 504. The splice loss 504 can be non-reflective and can be a result of a splice in the fiber. Connectors in the fiber can show both loss 503 and reflections 501 on the OTDR trace 500, The reflections can show OTDR pulse width and resolution on the OTDR trace 500. In various aspects, the slope 502 of the trace can show fiber attenuation and can be used to characterize a fiber attenuation coefficient. Importantly, the present disclosure can include knowing the time between the launch of the pulse and the receiving of the spike and can further include determining the location of the reflection event based on the time between the launch of the pulse and receiving of the spike. Point losses, such as from a fusion splice can cause a sudden drop in the reflected power which can be located in the fiber. Such sudden loss can be the splice loss 504.

### OTDR Trace Interpretation

Turning now to FIG. 5, an alternative example OTDR trace through a fiber with analysis of the courses of various events or features in the data in accordance with the present disclosure is shown and described. It should be noted that the FIG. 5 depicts a non-limiting example only of the OTDR trace 500. Moreover FIG. 5 depicts an interpretation of the data resulting from the OTDR trace 500. The OTDR trace 500 includes data, which can be graphically represented or plotted. The OTDR trace 500 graph can show the distance 505 which can be measured in length, such as kilometers, and a power level 601, which can be measured in decibels. In further example, the power level 601 can define the y-axis and the distance 505 can define the x-axis. The trace from the OTDR trace 500 can be a line defining the slope 502 on the graph. The initiation of the OTDR trace 500 on the graph can define a fiber source connector 603b. The source connection 603b can correlate to a point where the light pulse is initiated. The source connector 603b can be the connection point where the OTDR or measurement device is connected to a fiber undergoing a test. The source connector 603b can be a launching point for test pulses into the fiber. The source connector 603b can be various types of fiber optic connectors for example SC, LC, ST, FC, and MPO. The OTDR trace 500 can include an end of fiber 603a. The end of fiber 603a can be the termination point of the fiber. The end of fiber 603a can be a physical end of fiber 603a or a functional end of fiber 603a. The physical end of fiber 603a can be a connectorized end which can be a fiber terminated by a connector or a bare fiber end. The functional end of fiber 603a can be a transmitter end defining the starting point of a fiber link, a receiver end defining the ending point of the fiber link, or a test equipment end.

The slope 502 can be a negative slope between the source connector 603b and the end of fiber 603a, wherein the power level 601 is lower at the end of fiber 603a relative to the source connector 603b. The OTDR trace 500 can define a noise 602 at an end of the trace. The noise 602 can appear after the end of fiber 603a. The noise 602 can be backscatter noise or end-of-fiber noise. Such noise 602 can be caused by the limitations of the OTDR and/or the scattering of light within the fiber. As used herein, backscatter noise can be inherent noise in the fiber caused by the scattering of incident light. For example, when the light pulse travels down the fiber, a small portion is scattered back towards the OTDR. The noise 602 can also be reflection noise, wherein the reflection noise can be remitted from the end of the fiber and can be any remaining light pulse which is not absorbed or scattered.

Comparison between multiple OTDR traces captured from the same fiber may reveal temporal changes in the fiber or its environment such as loss variation resulting from a loose connection. Correlating temporal measurements with similar measurements from another fiber may indicate shared risk.

More generally, the OTDR traces 500 or measurement signatures can be graphed and can reflect certain events or physical properties of the fiber. In a general example, the OTDR trace 500 can define source connectors 603b, connectors, splices, bending, cracking, and the end of fiber 603a. The graph can demonstrate such properties as the reflections, the slope 502, the loss 504, the splice loss 504, and the noise 602. In typical embodiments, the OTDR trace can be configured to measure bend losses in the fibers. Further, the present disclosure can include identifying bend losses amongst fibers wherein the bend losses happen at similar locations. It is envisioned that correlating the location of fibers if the fibers exhibit similar bend losses from a substantially similar geographic location or within a common infrastructure. Here we use the word graph to refer to a graphical representation of the OTDR data. It should be understood that the data may be analyzed through a variety of means, not limited to graphical analysis, such as methods employing computer algorithms and machine learning.

Another event which can affect the Rayleigh backscatter can be caused by a changed in the Mode Field Diameter (MFD). As used herein, MFD can refer to the effective diameter of the core area of the fiber where the majority of the light pulse propagates in a single-mode optical fiber. Importantly, the MFD is not the physical core diameter but rather a measurement of the optical field distribution of the fiber. Moreover, MFD can be a characteristic of the fiber which can change between different types of fiber (e.g., G.652 (Non-Dispersion Shifted Fiber (NDSF)) and G.655 (Non-Zero Dispersion Shifted Fiber (NZDSF)). MFD can be caused when fibers of different types are spliced together and is often measured in micrometers. The result can be a different amount of backscattering which affects the apparent losses. In certain aspects, the MFD can appear as a gain (often referred to as a gainer) in the OTDR trace 500. MFD can be important as it can affect the coupling efficiency of the light between fibers or between a fiber and an optical device (e.g., a laser emitter, a detector, etc.) and can lead to higher insertion losses. More generally, the OTDR traces can be configured to identify different fiber types. The OTDR trace can be configured to identify varying fiber types at similar locations.

The following table provides an example of MFD in OTDR traces 500:

| | | |
|---|---|---|
| Bigger MFD | Smaller MFD | +.20 dB (exaggerated loss) |
| (i.e. G.655/6) | (i.e. G.652) | |
| | | True Loss = .05 dB |
| Smaller MFD | Bigger MFD | −.10 dB (gainer) |
| (i.e. G.652) | (i.e. G.655/6) | |

### Trace Identification

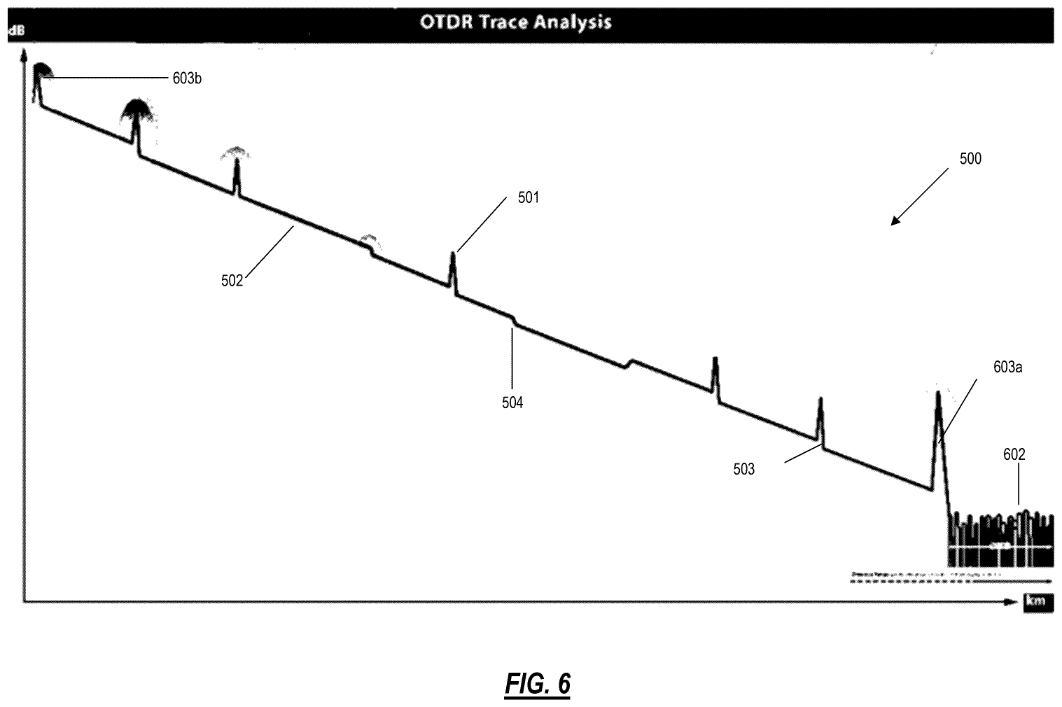

Turning now to FIG. 6, a bidirectional analysis of OTDR traces with correlation to cable location in further accordance with the present disclosure is shown and described. In some aspects, one or more disruptions in the slope 502 can be an event. The events can be seen along a portion, or all of the distance of the fiber as shown in FIG. 6. The present disclosure can include a bi-directional analysis. The bi-directional analysis can include OTDR traces from both ends. The bi-directional analysis can increase the accuracy of the measurements. For example, such analyses can aid in identifying and mitigating discrepancies in measurements directionality. With the bi-directional analysis, it can be possible to obtain more information when compared to a single direction OTDR. In certain aspects, the bi-directional analysis can substantially double the probability that an event can be detected, and the location can be correlated from both ends of the fiber. FIG. 6 depicts multiple OTDR events in a single cable which can be correlated between fibers in two directions. Some embodiments can include using a bi-directional analysis in part with OTDR trace measurements.

### OTDR Trace as a Fingerprint

As used herein, the term “bundle,” “conduit”, “cable, and “common infrastructure” generally refers to a collection of two or more fibers which share something in common with one another physically. The OTDR can be used to identify characteristics of any of the fibers in the bundle. That is, each fiber can exhibit specific patterns in the shape of the OTDR trace 500 as a result of their unique physical properties. Moreover, given the complexity and length of such fibers, each fiber or bundle of fibers can be associated with a certain OTDR trace 500 which can been seen on the corresponding graph. Features in the OTDR data for a fiber may be used to define a “fingerprint”, wherein the fingerprint represents features which are present in an OTDR trace 500 that are specific to fibers which co-propagate for all or part of their path. This could include fibers which are in the same bundle. Typical aspects of the present disclosure include measuring and identifying fingerprint(s) of each fiber. The data OTDR can provide a means to correlate multiple fibers based on their associated fingerprint. Again, the measurement technique, such as the OTDR can be used to identify one or more characteristics or combination of characteristics that are unique to fibers, or fiber paths, and can be used to identify fibers which have fully or partially overlapping paths. Note that the fingerprint may apply to the full length of the fiber or fingerprints may be defined for different regions of the fiber and the associated parts of the OTDR trace. For example, a fingerprint may be defined for the pattern of losses experienced by a fiber that passes through a conduit under a bridge.

Just as each fiber, or path, can define its own fingerprint or specific physical characteristics which can be measured by the OTDR trace 500, multiple fibers can be categorized as a sharing one or more fingerprints and thus being associated with an SRLG. In other words, an event can influence the “fingerprint” of fibers and introduce a commonality between the fibers. Moreover, environmental or physical effects are likely to affect fibers in a shared risk group than affect them individually. Losses due to splices at the same location, bend losses, changes in fiber type commonly happen at the same location for fibers in the same cable or conduit. Therefore, looking at OTDR traces with similar events at similar locations or relative spacing of similar events can allow some fraction of fibers to be discovered to have the same physical cable or conduit and therefore a shared risk. Taken as a whole, the OTDR traces 500 can provide a means to correlate fibers in terms of the common effect that may be experienced due to shared risk.

In further example, fibers in a bundle can be identified in a shared risk if, for example, they show similar signs in the fingerprint. In an illustrative example, fibers in the bundle can have similar splices, connectors or bends which can be correlated. When the correlation is found, a SRLG can be identified. The bi-directional analysis can be used to confirm the measurements and identification and/or increase the accuracy thereof. A cloud-based storage of data can be used to store collected data from the measurements which can be OTDR traces. The cloud-based storage can be configured to collect and store data from the network element (NE) or any device in a telecommunication network which can be independently managed. A process running in the cloud environment can analyze the data and can optionally determine where there are potential shared risks fibers based on the data. The data can result from any physical measurement, such as OTDR traces. Some embodiments can include providing results of the analysis to the NE or any portion to a system or a user. The data pertaining to the fibers can include complete or partial location data for the fibers, a degree or extent of commonality based on the “fingerprint” and the proximity of the fibers to one another. Such data can be used to create SRLG data pertaining to fibers. More generally, the data can be used to identify a physical measurement, such as a OTDR trace corresponding to each fiber in an optical network and correlating the data. The correlation can be based on comparing one or more aspects of the physical measurements, for example one or more aspects of the OTDR trace. Advantageously, the OTDR traces, or generally the physical measurements can be configured to identify connectors on the fibers at similar locations based on the degree of commonality of the “fingerprint”. Other parameters can be extrapolated from this data for example, connectors on the fibers which are at similar locations can indicate the fibers exit from a same cable or conduit for the common infrastructure.

In illustrative example only, the present disclosure provides a cloud-based storage which contains therein data defined by one or more “fingerprints” of the fibers or bundles, wherein the data can be collected by a OTDR trace. The cloud can include a process which can be configured to identify similar fingerprints among the data and determine which fibers are substantially similar. Further, the example can include determining where there is shared risk based on the similarity of the fiber's fingerprints. The data stored in the cloud can be used in generating an SRLG based on the data and can optionally provide an estimate of the probability that the shared risk is real. Again, the measurements can determine the probability of fibers existing withing a SRLG based on the degree of similarity between the trace or “fingerprint” of individual fibers. Further, the present disclosure can prove a means to propagate the resulting SLRG data. The propagation can be a notification, a wireless transmission, an update, or any similar notification to a server or user. In certain situations, the data can be removed, revised, or updated based on data from fibers that do not share similar geographical locations. For example a determination can be made based on whether or not fibers are housed together by examining the fiber's signature or “fingerprint” and share similar geographical proximity, and optionally filtering out data regarding fibers which do not share geographical proximity.

In general aspects, feedback can be received based on details generated from the SRLG estimation. In example, the method can make a determination which includes using the OTDR traces to determine the probability that fibers reside in a similar location, and therefore can determine whether the fibers define a SRLG. The method can propagate this information and can include receiving feedback based on the results from the determination. The method can provide feedback wherein the feedback includes at least information regarding the SRLG of fibers. The method can perform a loop wherein the feedback is used to update a correlation between the fibers. The correlation can define any similarity between two or more fibers, such as their fingerprint, geographical location, or SRLG.

The method of can include propagating an identified SRLG into a location within the NE or network management system (NMS). The method can include providing a planning tool to help the user and/or the system avoid the use of shared risk elements when diversly routing channels to provide network resiliency. The incorporation of at least one of the elements can increase network availability and reduce service downtime risk. More generally, similar events happen at similar times if the fibers are a part of the SRLG. As a result, the method contemplates identifying fibers in a SRLG based on a OTDR trace which can identify such similarities between fibers.

The method provides for the identification of SRLGs of fibers where the physical measure quantifies a polarization phenomenon or polarization mode dispersion (PMD). The measures may indicate a change to a new steady state value. Similarly the temporal variation of the measure may be analyzed and correlated between fibers. Those skilled in the art will recognize that any physical measure which is sensitive to the environment surrounding the fiber may be used in a similar way. The method can include monitoring the behavior of light in a bundle of fibers based on a phenomena or natural occurrence. For example, if a phenomena or natural occurrence were to affect fibers, it could indicate that said fibers are in proximity and can be therefore each part of a SRLG. More generally, similar fibers are affected substantially similarly by a phenomena or natural occurrence if said fibers are in the same SRLG. Fibers can be affected by electrical and electromagnetic disturbances, such as lighting strikes, or by mechanical phenomenon such as vibrations. More generally, natural phenomena or natural occurrence which can affect multiple fibers can be, but are not limited to, indirect electrical interference such as nearby conduit interaction, induced currents from high voltages, electromagnetic pulses, or physical damage such as direct hits or infrastructure damage, mechanical vibrations. When such disturbances occur, they often effect more than one fiber in the bundle of fibers. Some methods can include identifying SRLG based on the resulting similar signal from simultaneously effected fibers. For example, lightning strike can induce an EML on a bundle of cables, which can be detected by, for example the polarimeter. The method can include assigning a SRLG to the fibers which were simultaneously affected by the lightning strike. It is important to note that the identification of SRLGs can rely on identifying polarization events which are identified at substantially the same time or place in two or more fibers. That is, if a polarization event or natural phenomena were to occur, the SRLG can be identified if two or more fibers show traces of the same event at the same time and/or location.

The method can include estimating the probability that fibers are in the same SRLG. In some methods, a number or identifier can be assigned to a fiber to provide a label or identification mark to the fiber, which can be based on its OTDR trace 500 or fingerprint. Some methods can include moving measurements taken from the OTDR trace to the cloud along with the number or identifier. It is envisioned that some methods can include automatically assigning a SRLG data to fibers which share common infrastructure. It is further envisioned that any method described herein can provide time-based measurements. For example, the physical measurements described herein can be time-based, such as measuring events, disturbances, direct hits, polarization transients, etc. OTDR traces are also physical measurements, but generally not time-based in that the OTDR traces measures the physical properties of a fiber, whereas the time-based measurements measure and detect an event at a given location and given time. With OTDR traces, we are looking for common physical properties, e.g., bends, splices, fiber type changes, etc. and these typically would show up in different OTDR traces taken at different times. With time-based measurements, we are looking for common events at the same time at similar locations, i.e., events that only occur once but are seen in different fibers.

The method can include using physical measurements to determine if two or more fibers share a common infrastructure. The method can include using polarization measurements from an OCLD. For example, the physical measurement can be polarization changes in the light pulse resulting from acoustic signatures in the fiber environment or from a natural occurrence, such as a lightning strike. Such physical measurements can be observed from multiple fibers and can occur at substantially similar times. The method can include measuring or identifying characteristics, fingerprints, or traces of two or more fibers. The physical measurements for traces, characteristics, or fingerprints can be taken via, for example, the OTDR. More generally, the method includes obtaining physical measurements which can result from a signal. Such signal measurements can provide information related to any of: characteristics of the fibers, time of the physical measurement, or condition of the fibers. The method can include the consideration of the time stamp of the physical measurement and/or specific details thereof.

The method can include associating a fiber with the timing of a physical measurement or properties of the physical measurement. The method can include identifying two or more fibers based on similarities between the time of the measurement or properties of the measurement. For example, two fibers which experience physical measurements at the same time as a result of a local natural signal such as an earthquake or lightning strike or human activity such as vibration resulting from a train passing near the fiber, can be correlated. In an alternative example, two fibers whish demonstrate a similar fingerprint, wherein the fingerprint is a result of for example localized damage, can be correlated based on the similar trace or fingerprint. More generally, the method includes correlating two or more fibers based on similar physical measurements.

The method can include determining if two or more fibers are proximal based on the similarities. In example, the method can include identifying two or more fibers which experience similar physical measurements as a result of a lightning strike or polarization event. In other aspects, the method can include comparing the properties of the physical measurements of two or more fibers wherein the physical measurements provide similar profiles. The method can include estimating the probability of the two or more fibers sharing proximity or common infrastructure. The method can include assigning a link or SRLG based on the commonality between the physical measurement. For example, if two or more fibers are defined by the physical measurement as having similar properties, or the physical measurement occurs at substantially the same time as a result of a natural signal, the method can include an estimation the proximity or commonality of infrastructure between the two or more fibers.

### Method of Determining SRLG

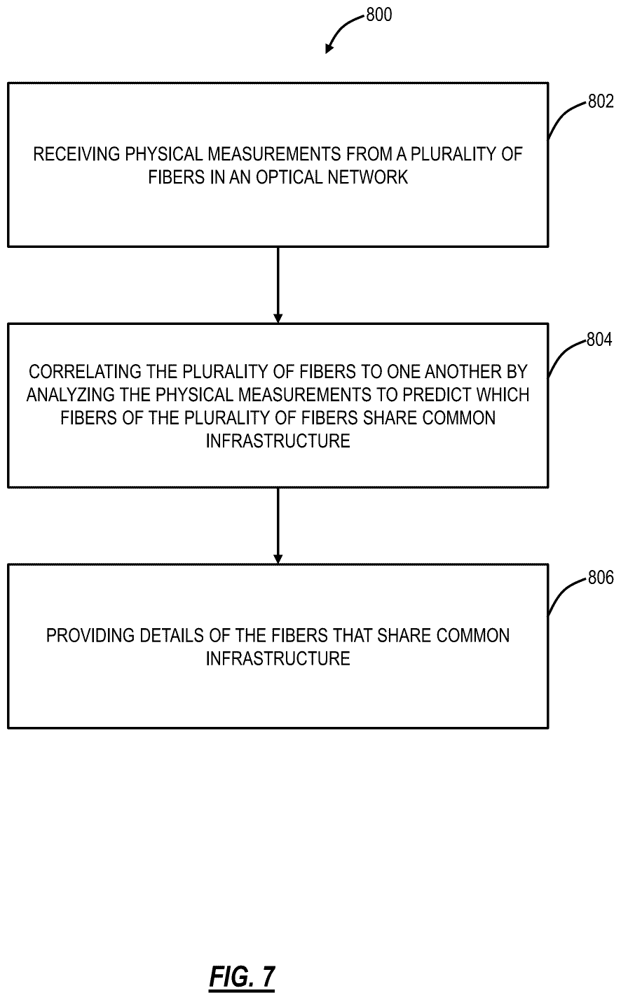

Turning now to FIG. 7, a flowchart of a process 800 for automatic shared risk link group detection in accordance with one aspect of the present disclosure is shown and described. The process 800 can be a method which can provide receiving physical measurements 802 from a plurality of optical fibers in an optical network. The process 800 can include correlating 804 the plurality of fibers to one another by the physical measurements to predict which fibers of the plurality of fibers share common infrastructure. The process 800 can include providing details 806 of the fibers that share common infrastructure.

Typical methods of the present disclosure can include automatically assigning SRLG data to the fibers that share common infrastructure. After the automatically assigning, it is possible to propagate the SRLG data into appropriate locations in the optical network. The appropriate locations can include NEs, NMS, planning tools, Path Computation Element (PCE), etc., i.e., any device, component, tool, etc. that can use the SRLG data for some purpose in the optical network, e.g., path computation, diverse routing, protection, etc. Some methods can include prior to the correlating, filtering out the plurality of fibers based on geographical locations or a corresponding length of any fibers. This filtering can reduce the number of fibers in the correlation, such that any fibers having geographical locations for endpoints that may be spaced apart could be excluded, or any fibers having different lengths from the endpoints could be excluded, etc. For example, geographically, a 100 km fiber on the East coast cannot share common infrastructure with a 100 km fiber on the West coast. Of course, there can be various similar techniques to filter fibers out prior to correlating them to one another. Other methods can include wherein the physical measurements are OTDR traces and wherein the correlating is based on comparing one or more aspects of the OTDR trace for identifying similarities.

In various aspects, methods can include wherein the one or more aspects of the OTDR traces include splices on the fibers being at a similar location thereby indicating a same cable or conduit for the common infrastructure. Further, some methods can include wherein the one or more aspects of the OTDR trace include connectors on the fibers being at similar locations thereby indicating exiting from a same cable or conduit for the common infrastructure. Typical aspects can include wherein the one or more aspects of the OTDR traces include different fiber types of the fiber types being at similar locations. The method can include bend losses in the fibers being at similar locations thereby indicating excess fiber for slack in the fibers for the common infrastructure. The method can include wherein the physical measurements are time-based results related to any of loss, event, and polarization changes and wherein the correlating is based on the fibers exhibiting similar time-based results. The method can include wherein the common infrastructure includes the fibers share one of a same cable and a same conduit. In typical aspects, the method can include receiving feedback based on the details, the feedback indicating whether or not the predicted fibers share the common infrastructure and utilizing the feedback for updating the correlation. The providing can also include presenting an estimate to a user of a probability that any two fibers actually share a risk.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

References to analysis or calculations performed in the cloud should be understood to encompass all types of compute infrastructure including without limitation compute from the public cloud, on premises deployments, computers operating as part of the telecommunications network, computers deployed in or in support of a network operations center, computers deployed as part of network elements, virtual machines etc.

References to relating OTDR traces, correlating OTDR traces and the like should understood to include features within the OTDR traces that are present in only part of the traces. The methods described herein apply to cases where fibers are proximal for only a portion of their total length.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments. Also, in the claims, the terms “comprise,” “comprises,” “comprising,” “include,” “includes,” and “including” are intended to be non-limiting and open-ended. These terms specifically list essential elements or steps but do not exclude additional elements or steps. This applies even when a claim or series of claims includes more than one of these terms.

What is claimed is:

1. A method comprising steps of:
receiving physical measurements from a plurality of fibers in an optical network;
correlating the plurality of fibers to one another by analyzing the physical measurements to predict which fibers of the plurality of fibers share common infrastructure; and
providing details of the fibers that share common infrastructure.

2. The method of claim 1, wherein the steps further include
automatically assigning Shared Risk Link Group (SRLG) data to the fibers that share common infrastructure.

3. The method of claim 2, wherein the steps further include
propagating the SRLG data to the optical network.

4. The method of claim 1, wherein the steps further include
prior to the correlating, filtering out the plurality of fibers based on geographical locations or a corresponding length of any fibers.

5. The method of claim 1, wherein the physical measurements are optical time domain reflectometer (OTDR) traces, and wherein the correlating is based on comparing one or more aspects of the OTDR traces for identifying similarities.

6. The method of claim 5, wherein the one or more aspects of the OTDR traces include splices on the fibers being at similar locations at some point thereby indicating a same cable or conduit for the common infrastructure.

7. The method of claim 5, wherein the one or more aspects of the OTDR traces include connectors on the fibers being at similar locations thereby indicating exiting from a same cable or conduit for the common infrastructure.

8. The method of claim 5, wherein the one or more aspects of the OTDR traces include different fiber types of the fibers being at similar locations at some point.

9. The method of claim 5, wherein the one or more aspects of the OTDR traces include bend losses in the fibers being at similar locations thereby indicating excess fiber for slack in the fibers for the common infrastructure.

10. The method of claim 1, wherein the physical measurements are time-based results related to any of loss, events, and polarization changes, and wherein the correlating is based on the fibers exhibiting similar time-based results.

11. The method of claim 1, wherein the common infrastructure includes the fibers sharing one of a same cable and a same conduit.

12. The method of claim 1, wherein the steps further include
receiving feedback based on the details, the feedback indicating whether or not the predicted fibers share the common infrastructure; and
utilizing the feedback for updating the correlating.

13. The method of claim 1, wherein the providing further includes an estimate of a probability that there is a shared risk between any two fibers.

14. A non-transitory computer-readable medium comprising instructions that, when executed, cause one or more processors to perform steps of:
receiving physical measurements from a plurality of fibers in an optical network;
correlating the plurality of fibers to one another by analyzing the physical measurements to predict which fibers of the plurality of fibers share common infrastructure; and
providing details of the fibers that share common infrastructure.

15. The non-transitory computer-readable medium of claim 14, wherein the steps further include:
automatically assigning Shared Risk Link Group (SRLG) data to the fibers that share common infrastructure.

16. The non-transitory computer-readable medium of claim 15, wherein the steps further include
propagating the SRLG data to the optical network.

17. The non-transitory computer-readable medium of claim 14, wherein the steps further include:
prior to the correlating, filtering out the plurality of fibers based on geographical locations or a corresponding length of any fibers.

18. The non-transitory computer-readable medium of claim 14, wherein the physical measurements are optical time domain reflectometer (OTDR) traces, and wherein the correlating is based on comparing one or more aspects of the OTDR traces for identifying similarities.

19. The non-transitory computer-readable medium of claim 18, wherein the one or more aspects of the OTDR traces include one or more of
splices on the fibers being at similar locations thereby indicating a same cable or conduit for the common infrastructure,
connectors on the fibers being at similar locations thereby indicating exiting from a same cable or conduit for the common infrastructure,
different fiber types of the fibers being at similar locations, or
bend losses in the fibers being at similar locations thereby indicating excess fiber for slack in the fibers for the common infrastructure.

20. The non-transitory computer-readable medium of claim 14, wherein the physical measurements are time-based results related to any of loss, events, and polarization changes, and wherein the correlating is based on the fibers exhibiting similar time-based results.
